(19) United States
(12) Patent Application Publication
(10) Pub. No.: US 2010/0271908 A1
(43) Pub. Date: Oct. 28, 2010

(54) Tectonic discharger

(76) Inventor: Bereli M. Lazar, San Francisco, CA (US)

Correspondence Address: Bereli M. Lazar, 1590 Broadway, Apt. 410s, San Francisco, CA, 94109, US

(21) Appl. No.: 12/653,672

(22) Filed: Dec. 17, 2009

Related U.S. Application Data
(60) Provisional application No. 61/214,625, filed on Apr. 27, 2009.

(51) Int. Cl. G01V 1/155

(52) U.S. Cl. 367/189

(57) ABSTRACT

The structure for severe earthquakes prevention includes :
at least one vibro-shock machine with a drive-adjuster,
at least one anvil shock-transmitter,
dry well unit, controls, seismographs,
   all placed in local epicenter area at upper tectonic plate.

The method is based on:
periodic operation of shock-vibrations with adjusted frequencies corresponding to own natural frequencies of hypocenter's plates,
direct transmitting of generated shock-vibrations to the hypocenter's plates, and exciting them at their resonance frequencies,
triggering small, controlled, artificial mini-quakes of low and safe magnitudes for preemptive dissipation of stressed plates' accumulated elastic energy, thus preventing a severe earthquake in future.

### RELATED APPLICATIONS

RPA No. 12/455,800 filed Jun. 8, 2009 and its PPA 61/214,625 filed Apr. 27, 2009, both then titled “Tectonic Shake Guard”. Author considers said applications as abandoned.

### FEDERALLY SPONSORED RESEARCH

Not applicable.

### SEQUENCE LISTING OR PROGRAM

Not applicable.

### TECHNICAL FIELD, UNDERGROUND

This proposal relates to the methods and techniques developed for severe tectonic earthquakes prevention. The offer deals with:
physics of elastic tectonic plates stressed in their slow motions,
shock-wave mechanics; shake-interactions in rock solid plates, based on usage their own natural resonance frequency,
mechanical waves transmitting and propagation, induced resonant oscillations in elastic stressed rock solids,
vibration machines, sensor controls, seismographs, seismograms,
reinforced concrete constructions, dry wells,
general mechanical and electrical infrastructures.

More then 200 violent earthquakes of magnitudes 6 to 8 occur in the world every year. Seismic areas need reliable technological protection.

A tectonic earthquake is a result of sudden release of stored over-accumulated elastic energy of tectonic plates, that creates seismic waves. The tectonic plates , being mostly rock-elastic, accumulate their energy by friction in slow motions, thus becoming gradually stressed and over—saturated with their own elastic energy.

The subject matter of this proposal is a method and means for periodic, controlled, adjusted operating of shock-vibrations generated by present Tectonic Dischargers in epicenters and directly transmitted to the hypocenters in order to excite, resonate, provoke, and trigger artificial, small, premature, controlled, safe mini-quakes, thus releasing the bigger portions of the accumulated plates' elastic energy. This averts the dangerous over-accumulation of plates' energy, and prevents possible severe earthquakes in near future technologically. The method of induced mini-seismic activity of very low, controlled, and safe levels provides systemic discharging off with smooth dissipation of already accumulated elastic energy in hypocenters.

This application is an improved, shortened version of abandoned No. 12/455,800; the new simplified design was developed after additional research and testing of newly corrected lab devices.

Any prior arts related to present method and means for preventing severe tectonic earthquakes with preemptive periodic shock-vibrations generated in epicenters at resonance frequencies of hypocenters' plates for their accumulated elastic energy controlled discharging and soft dissipating, were not found.

### BRIEF SUMMARY OF THE INVENTION

The proposal represents a method and means for periodic prevention severe earthquakes. The nature and substance of said means include:
vibro-shock machines with drive-adjusters and frame-transmitters,
anvil shock-transmitters, each with two kits of protected anchors,
controls with sensors and seismographs, general infrastructure,
dry well units placed in epicenter area.

The method of Tectonic Discharger's work is grounded on:
periodic, 2 to 3 times a year, operating of shock-vibrations at adjusted frequencies close to the natural own, resonance frequencies of the stressed tectonic plates, usually known from recorded seismograms of previous local earthquakes,
direct transmitting of generated in epicenter shock-vibrations to the tectonic plates of hypocenter in forms of down shock-fronts, exciting, resonating, and triggering the controlled, recorded, artificial, response mini-quakes of low safe magnitudes for preemptive releasing of plates' accumulated elastic energy, thus preventing severe earthquakes which could be possible in the case of non-discharging.

### DRAWING FIGURES

In the drawings, closely related elements have the same numbers, but different alphabetic suffixes.

FIG. 1 is a sectional scheme of the Tectonic Discharger's operation.

FIG. 2 is a front-sectional view of the fragment 2 taken in FIG. 1.

FIG. 3 is a cross-section 3-3 taken in FIG. 2.

FIG. 4 is a set-graph with overlapped seismograms of operating shock-vibrations and response mini-quakes in their common time-periods.

### REFERENCE NUMERALS AND CHARACTERS

20—vibro-shock machine 20A—casing 21A, 21B—unbalances 22—electric motor 23—drive-adjuster 24A, 24B—dry well units 25—upper stop 26—frame-transmitter 27—rigid spacer 28—spacer 30—control block 31—phase lag controller 32A, 32B—seismograph kits 40—anvil shock-transmitter 41A, 41B—anchors 50—epicenter area 50A—a town 51—hypocenter zone 52 A,B,C,D—tectonic plates 53—upper layer 54—plate border 60—shock-vibrations 60S—shock seismogram 61—down shock-front 62—response mini-quakes 62S—quake seismogram

A—recorded amplitudes of oscillations T—time periods Au, Ad—up and down amplitudes of shock-vibrations 60, respectively Aiq—average amplitude of the response mini-quakes 62 Tbg, Tad, Top, Tex—time periods of beginning, adjusting, operating, and exit steps of the vibro-shock machine work, respectively Ur—unbalances' 21A and 21B interconnected synchronized rotations

A note: the reference numerals 22, 23, 24A,B, 30, 31, 32A, B are conventional units, corrected and used in present new proposal.

### DETAILED DESCRIPTION OF THE INVENTION

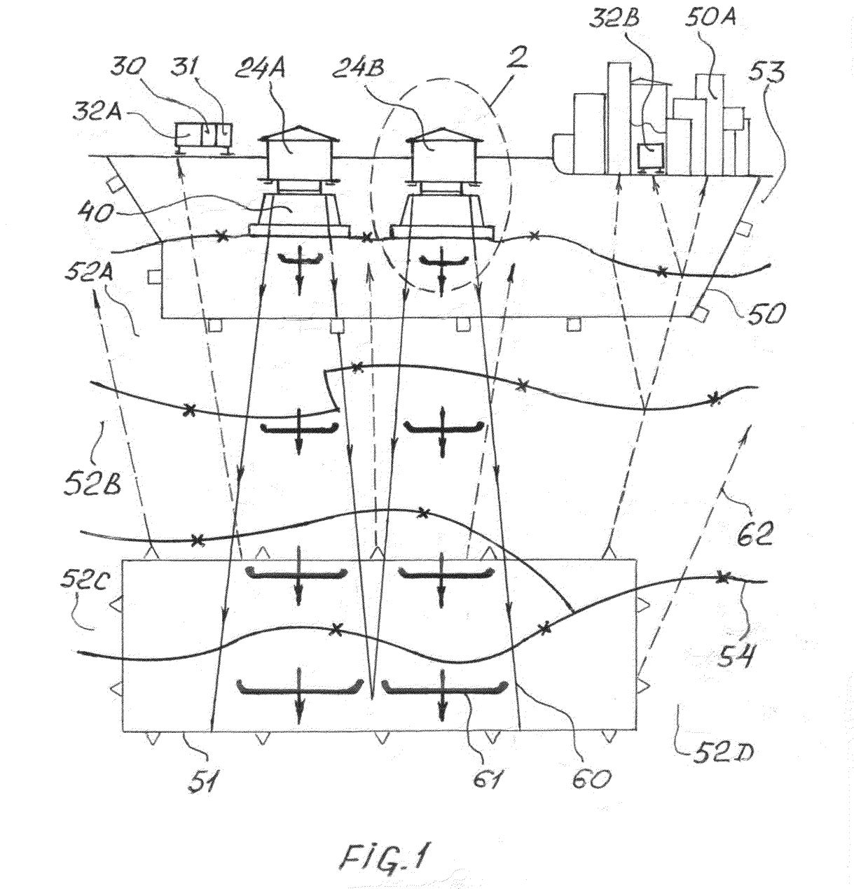

The structure may include several Tectonic Dischargers. FIG. 1 shows how two Dischargers connected with dry well units 24A, 24B, anvils 40, all placed in epicenter area 50 above hypocenter zone 51, work together. Also are shown: controls and seismographs 30, 31, 32A, 32B, tectonic plates 52A,B,C,D, shock-vibrations 60 with their down shock-fronts 61, resonated response mini-quakes 62, and other indicated elements.

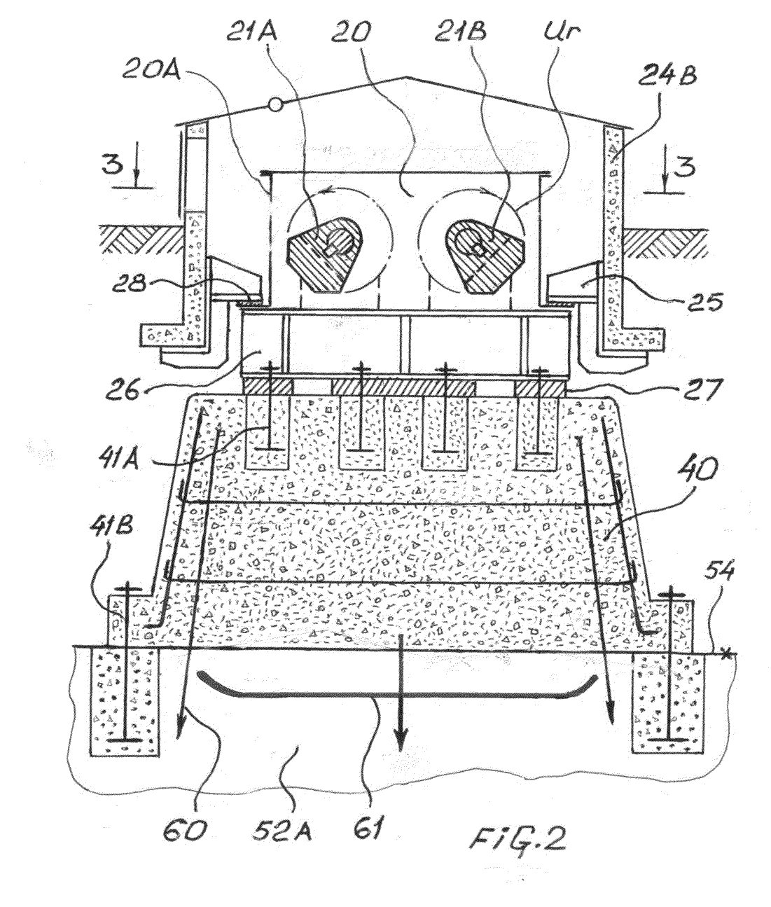

FIG. 2 illustrates a typical arrangement of Tectonic Discharger's units. Are shown: vibro-shock machine 20 with rotating unbalances 21A, 21B, frame-transmitter 26 with rigid spacers 27, anvil shock-transmitter 40 with anchors 41A and 41B, shock-vibrations 60 and their down fronts 61, dry well unit 24B, upper tectonic plate 52A, other indicated elements.

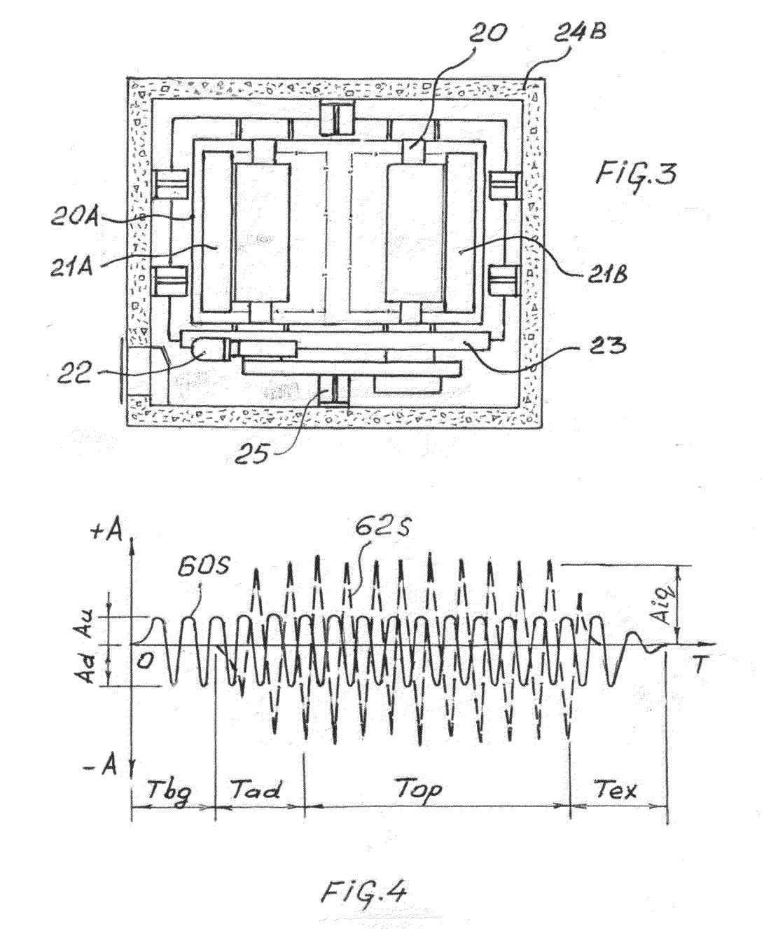

FIG. 3 shows drive-adjuster 23 of the vibro-shock machine 20, electric motor 22 , and other mentioned above elements. Upper stops 25 protect anchors 41A and 41B from portions of up-directed periodic inertial forces of rotating unbalances 41A,B.

FIG. 4 demonstrates concurrent seismograms 60S and 62S in their common resonance frequency and the same time periods.

### Operation

The work of the Tectonic Discharger is periodic, 2 to 3 times per year with sessions up to 15 minutes. The time periods depend on depths of local hypocenter zone 51, number of tectonic plates 52, and on level of correct resonance frequency adjusting and operative control.

A Discharger, used in a definite epicenter, starts at frequencies of shock-vibrations 60 according to those previously recorded by the last seismograms of earlier occurred local natural earthquakes.

The unbalances 24A and 24B in their synchronized rotations Ur develop adjusted inertial forces generating shock-vibrations 60 which are transmitted by frame 26, rigid spacers 27, and reinforced - concrete anvil 40 at resonance frequency in forms of down shock-fronts 61.

Said fronts 61 penetrate through elastic tectonic plates 52 A,B,C,D and get to hypocenter zone 51 exciting there the resonated response mini-quakes 62 which are recorded with seismographs 32A,B.

Due to the operative seismograms 60S and 62S , controls 30, phase lag controller 31, drive-adjuster 23 provide additional regulations in order to get appropriate levels of resonated response mini-quakes 62.

The plates 52, like spring-loaded systems which are ready to go off, resonate when down shock-fronts 61 at corresponding plates' own natural frequencies, are imposed upon them.

The plates 52 become step by step excited, jarred off and loose their accumulated elastic energy oscillating under doubled record of two separated seismographs 32A and 32B.

The substantial portion of tectonic plates 52 elastic energy in hypocenter zone 51 is dissipated in forms of response mini-quakes 62, and possible plates' energy over-accumulation in near future is locally stopped. Said seismic energy is dispersed preemptively.

The possible severe earthquake is averted and prevented before it might occur around the epicenter area 50 in near future.

1. A Tectonic Discharger for solid underground plates' elastic energy periodic soft dissipating in order to prevent severe earthquakes, and consisting of dry well unit, seismographs, controls, comprises:
at least one vibro-shock machine with drive-adjuster, and
at least one rigid anvil shock-transmitter.

2. The Tectonic Discharger of claim 1 wherein said vibro-shock machine includes a frame-transmitter with rigid spacers for vibro-shocks direct transmission when adjusting and operating.

3. The Tectonic Discharger of claim 1 wherein said anvil shock-transmitter is connected to both said frame-transmitter and top underground tectonic plate, and comprises two kits of anchors protected from up-portions of periodic shock-forces with stoppers attached to said dry well unit.

4. The Tectonic Discharger of claim 1 wherein any assembly, including said vibro-shock machine, anvil shock-transmitter, and dry well-unit, is placed in local epicenter area above seismic hypocenters.

5. The Tectonic Discharger for solid underground plates' elastic energy systematic controlled dispersing, thus to prevent severe earthquakes, comprises a technological method based on:
a) periodic operation of shock-vibrations at frequencies resonating with own natural tectonic plates' frequencies, and
b) direct transmitting said resonant shock-vibrations in forms of down shock-fronts from epicenters to stressed tectonic plates in hypocenters for said tectonic plates soft adjusted exciting, and
c) provoking and triggering small controlled artificial mini-quakes of low and safe magnitudes for early controlled releasing of said plates' accumulated energy, thus preventing possible severe earthquakes in near future in case of not discharging.

6. The Tectonic Discharger of claim 5 wherein said method includes regulations of frequencies and forces of said shock-vibrations during adjusting and operating, thus providing optimum and proper soft and safe plates' elastic energy dissipation.

7. The Tectonic Discharger of claim 5 wherein said method includes doubled recording of operations provided by two separated seismograph kits both placed in epicenter area.
